(19) United States
(12) Patent Application Publication
(10) Pub. No.: US 2008/0282005 A1
(43) Pub. Date: Nov. 13, 2008

(54) METHOD AND PROCESSING UNIT FOR INTER-CHIP COMMUNICATION

(76) Inventors: Edward Chencinski, Poughkeepsie, NY (US); Andreas Koenig, Leonberg (DE); Todd E. Leonard, Williston, VT (US); Daniel E. Reed, Essex Jct., VT (US); Thomas Schlipf, Holzgerlingen (DE)

Correspondence Address: IBM MICROELECTRONICS;INTELLECTUAL PROPERTY LAW, 1000 RIVER STREET, 972 E, ESSEX JUNCTION, VT, 05452, US

(21) Appl. No.: 12/113,528

(22) Filed: May 1, 2008

(30) Foreign Application Priority Data
May 2, 2007 (DE) 07107337.3

(51) Int. Cl. G06F 13/00

(52) U.S. Cl. 710/105

(57) ABSTRACT

The invention relates to an inter-chip communication protocol, based on a standard interface protocol, which is adapted to incorporate control, configuration and/or recovery information for computer chips, and the data encoded within communication packets of a communication layer above the physical layer of the interface protocol.

### FIELD OF THE INVENTION

The field of the invention relates generally to inter-chip communication and more particularly to a method and structure implementing a protocol for inter-chip communication based on a standard interface protocol.

### BACKGROUND OF THE INVENTION

Current computing systems consist of a set of discrete chips, including microprocessors, I/O chips and memory chips, and have a system wide control structure for the major configuration, control and recovery functions. Such computer systems either employ dedicated interfaces between the different chips for all communication related to these tasks or use special command types traveling through the system using the main data path or interfaces.

Systems that use both methods for control, configuration and recovery communications are typically using only one of the described access methods at a time due to system limitations. For example a JTAG (Joint Test Action Group) interface is used for an initial setup of a chip while a dedicated command type traveling along the main data paths is used for this kind of communication during the regular runtime of the system.

While a dedicated control interface like JTAG typically guaranties a reliable access method to a chip even during misconfiguration, failure or traffic backing situations, such an additional interface generates additional costs and effort due to additional chip pins, wiring and system structures. Control communication via the main data path on the other hand is extremely unreliable if not even unavailable due to the described problems like misconfiguration, failure or traffic backing in any of the numerous logical units in the main data path, especially during those situations where this kind of communication is needed most.

FIG. 1 shows the basic principle of inter-chip communication between computer chips 1 and 2, wherein thin double-sided arrows indicate inband control traffic and broad double-sided arrows indicate data traffic. Chip 1 consists of a processing unit PU running a recovery firmware and logical units M1 (Macro 1) and M2 (Macro 2). Chip 2 represents an I/O chip having no own processor and incorporates macros M1 . . . M7 and logical unit C (Control). Due to error conditions in computer chips, including I/O chips without a processor running recovery firmware, the main access path may experience an access conflict and therefore unusable and recovery may not be possible. This is indicated by crossed out macro M4, a defect of which interrupts control and data throughput.

FIG. 2 shows a prior art solution to the communication problem in FIG. 1. In order to increase the recoverability of I/O chips, typically a dedicated second interface beside the main data path is available for control accesses. An example is the JTAG interface. However, due to system limitations such as pin availability, wiring, firmware support etc. the cost for such a second interface, in this case FSI, FSI′ on chips 1′ and 2′, respectively, can be very high and an alternative might be desirable. In other words, this solution needs extra pins and wiring for the dedicated second interface for control traffic FSI, FSI′, which equally increases required space and costs.

### SUMMARY OF THE INVENTION

It is therefore an object of present invention to overcome the drawbacks of the prior art as set out above and to provide reliable inter-chip communication in a simple and cost efficient manner.

This object is achieved by the invention as defined in the independent claims. Further advantageous embodiments of the present invention are defined in the dependant claims.

The preferred embodiments disclosed herein realize a communication protocol for inter-chip communication, which is based on a standard interface protocol adapted to incorporate control, configuration and/or recovery information for computer chips. The transmitted data is encapsulated within communication packets of a communication layer above the physical layer of the interface protocol.

One essential point of the new control traffic dedicated communication protocol according to the invention is that such protocol allows a reliable communication requiring only basically initialized connection of a main communication path. This communication bypasses all critical macros since the chip related information, for example control, configuration and/or recovery information, is encapsulated in a low layer of a standard communication protocol. Such communication enables error recovery, which is typically a deadlock, and reestablishment of the traffic. However, the new protocol may also be used during hardware initialization, in order to go around not yet sufficiently initialized hardware components for error recovery. Furthermore, during hardware initialization, the new protocol may be used to regularly/initially set up or configure non-initialized or not completely initialized hardware components. In any case an additional interface becomes superfluous, ie extra pins and wires are saved.

According to one preferred embodiment, the communication packets are manufacturer specific flow control packets defined by OpCodes (Operation Codes), which are not used by the standard interface protocol. That is, the basic structure of the standard communication protocol must not be changed. Proprietary enhancements may be introduced using open resources, which is easy and cost effective.

A variety of error cases may be handled if the OpCodes defining the communication packets each indicate different kinds of information. This extends the protocol to cover any failure occurring in control, configuration and/or recovery of chips, and is therefore extremely reliable. Furthermore, using different OpCodes, the information carried by the protocol is not restricted to mere failure management. For example, recovery of a system may require initialization of components. However, many such mechanisms may also be employed in regular control of a system, e.g., for initially preparing macros in routing, credits etc. before they are able to take up operation.

The amount of information to be transferred may be increased if such information is split up into several data packets having a header and a sequence number field. This allows restoring the full message of manufacturer specific flow control packets extending a defined length.

Preferably, the inventive enhancement of a standard interface protocol is made to an InfiniBand® protocol, preferably of Version 1.2. InfiniBand® which is a trademark of the InfiniBand® Trade Association is a switched fabric communications link primarily used in high performance computing. Its features include quality of service and fail over, and it is designed to be scalable. The InfiniBand® architecture specification defines a connection between processor nodes and high performance I/O nodes such as storage devices.

In particular, the networking layer of the InfiniBand® protocol may be used as the communication layer for transferring the chip related information. Such layer allows definition of a manufacturer specific subtype of flow control packets specified by the InfiniBand® standard, which are also transferred on a very low layer of the InfiniBand® communication protocol.

The InfiniBand® standard defines a 32-bit flow control packet used to control the traffic flow on the link level. These packets contain a 4-bit OpCode field. However, only OpCode 0×0 and 0×1 are used by the InfiniBand® standard. If OpCodes defining the communication packets are different from 0×0 and 0×1, the content of the remaining 28 bits is not defined by the InfiniBand® specification, i.e. open for proprietary enhancement according to the invention.

The communication protocol is implemented by a method for inter-chip communication, wherein a communication protocol (CP) based on a standard interface protocol (SIP) is used. First, chip related information comprising data relevant for at least one of the following: control, configuration, recovery must be determined. The data must be encoded within communication packets of a communication layer above the physical layer of the interface protocol. The packets are then inserted into a regular traffic flow of the sending chip. The packetized data is then extracted from an incoming data stream on the receiving chip.

One essential point of the communication method disclosed in the preferred embodiments is that the advantages of both current access methods for control, configuration and recovery functions, namely dedicated interfaces and special command types, are combined. The encoded low-level communication can transfer all manner of required messages and commands in both directions. It further allows a pretty reliable and direct access for nearly no additional costs, using the existing pins and wires. Moreover, it is not exposed to any kind of communication problem on the main data path, due to the fact that—besides the link protocol engine and the physical layer—no additional logical units involved in the main data communication are used, like routing, translation, buffering, checking etc.

The preferred embodiment includes a processing unit for inter-chip communication connected to a link protocol engine of a main interface to a neighboring chip. The processing unit is connected to on-chip control and configuration logic.

One essential point of the processing unit according to the preferred embodiment is that architected manufacturer specific flow control packets or any other comparable low level communication packets of the adopted interface protocol can be employed for control, configuration and recovery communication. This solution does not need separate pins or wiring nor is it exposed to most of the misconfiguration, failure or traffic backing problems in the main data path. Preferably, in order to save space and costs, the processing unit is integrally formed with a processing unit and/or a control unit of the same integrated circuit.

### BRIEF DESCRIPTION OF THE DRAWINGS

Referring to the exemplary drawings wherein like elements are numbered alike in the several Figures:

FIG. 1 a block diagram illustrating inter-chip communication between discrete integrated circuit components in the presence of a failure of an intervening logic macro;

FIG. 2 a block diagram illustrating a prior art solution to overcombing the logic macro failure depicted in FIG. 1;

FIG. 3 a block diagram illustrating a solution to the logic macro failure illustrated in FIG. 1 according to a preferred embodiment;

FIG. 4 a block diagram illustrating the networking layer of the InfiniBand®protocol to be used as a standard interface protocol, and

FIG. 5 a block diagram illustrating a communication layer according to the invention based on the networking layer of FIG. 4.

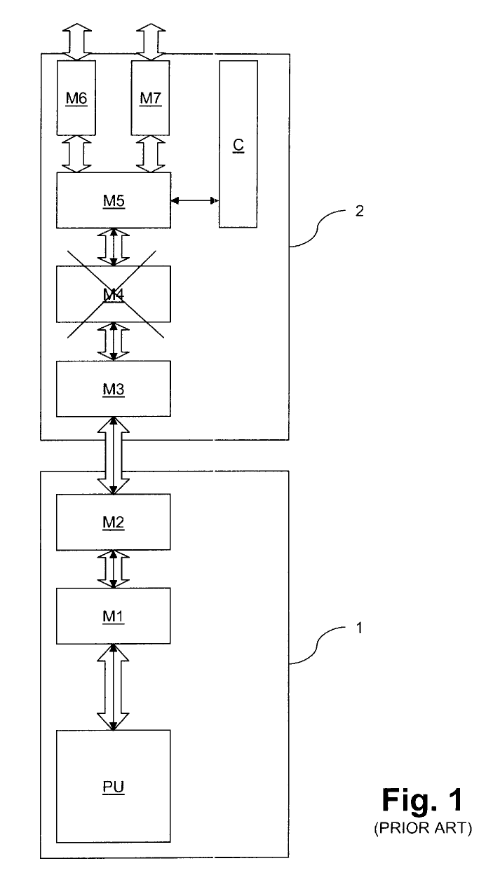

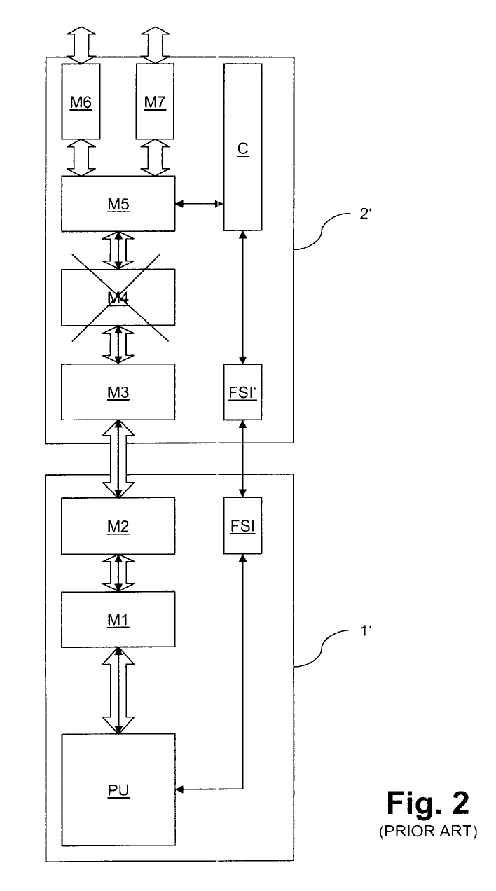

### DETAILED DESCRIPTION

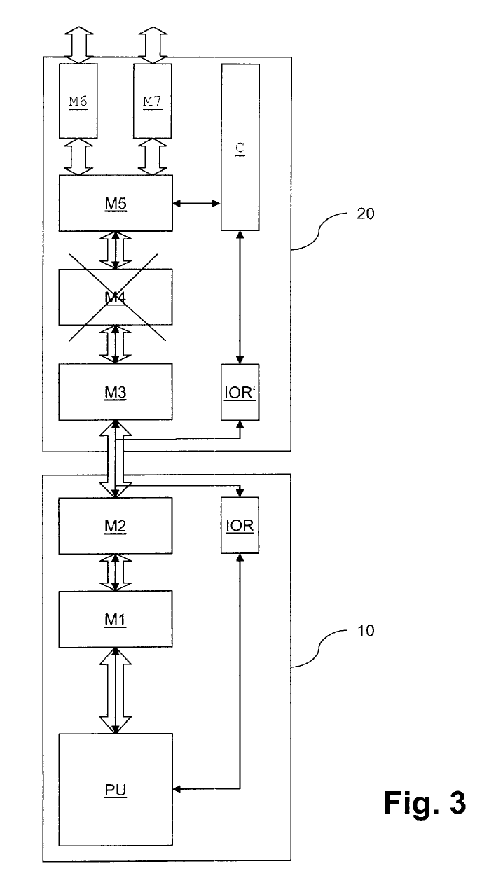

Referring to FIG. 3, a solution for maintaining inter-chip communication in the presence of a logic macro failure is shown. Integrated circuits 10 and 20 incorporate the same processing unit PU, control logic C and logical units or macros M1 . . . M7. Control traffic is indicated by way of thin double-sided arrows and broad double-sided arrows indicate data traffic.

Integrated circuit 20 is an I/O chip in a computer system incorporating I/O Recovery Logic (IOR), which uses SFCPs (Special Flow Control Packets) to be communicated via an InfiniBand® link from chip to chip. SFCPs are a manufacturer specific subtype of flow control packets specified by the InfiniBand® specification and transferred on a very low layer of the InfiniBand® communication protocol. Since this is the case, failure of macro M4, which is crossed out, will not prevent chip 10 from accessing the control logic C of chip 20 via the main communication path between the chips 10 and 20.

Logical processing units IOR and IOR′ each have a dedicated connection to an LPE (Link Protocol Engine) of the InfiniBand® link at macro M2 and M3 in order to send and receive all flow control packets using specific OpCodes. On the other hand, IOR and IOR′ each are connected to the processing unit PU and the control unit C their chip 10, 20, respectively. Therefore, extra pins and wiring for a second interface as known from the state of the art are superfluous. Furthermore, such logic is not exposed to misconfiguration, failure or traffic backing and overflow problems in the main path.

The IOR′ on chip 20, besides being connected to control logic C, may also be wired to the various macros M3 . . . M7 in a switch fabric configuration to all of them. The connection between unit IOR′ and control C is used to send configuration data, which are distributed from the control C over the regular control network. Furthermore, RESETS of all macros are controlled by logic C and therefore RESETS of the macros M3 . . . M7 will be requested or executed by unit IOR′ via logic C. The above mentioned additional wiring of unit IOR′ to macros M3 . . . M7 is used to directly monitor the state of these macros and to notify unit PU on chip 10 via SFCPs about errors in such macros on own initiative. Furthermore, direct control wiring may be provided between unit IOR′ and said macros M3 . . . M7 for e.g. a QUIESCENT operation, which minimizes the number of running processes in order to initially stop the user data stream e.g. in macro M3 and M5 before macro M4 is resetted. In principle, the above mentioned functions of unit IOR′ may also be realized within logic C in order to save space and costs.

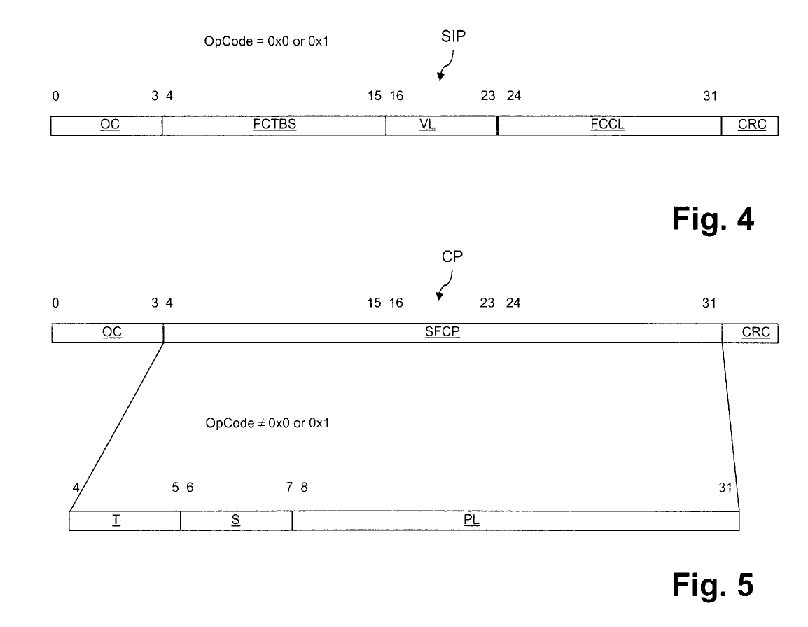

FIG. 4 shows the networking layer of the InfiniBand® protocol to be used as a standard interface protocol SIP (Standard Interface Protocol), wherein values ×0 or 0×1 in field OC (OpCode, bits 0-3) indicate that there is control information carried along in field FCTBS (Flow Control Total Blocks Send, bits 4-15), field VL (Virtual Lane, bits 16-23) and in field FCCL (Flow Control Credit Limit, bits 24-31). A cyclical redundancy control CRC is appended to the latest bit. Thus, the InfiniBand® standard altogether defines a 32-bit flow control packet used to control the traffic flow on the link level. These packets contain a 4-bit OpCode field. However, only OpCodes 0×0 and 0×1 are used by the InfiniBand® standard. If OpCodes different from 0×0 and 0×1 are used, the content of the remaining 28 bits is not defined by the InfiniBand® specification.

FIG. 5 shows a communication layer of a communication protocol CP (Communication Protocol) according to a preferred embodiment based on the networking layer of FIG. 4. OpCodes different from 0×0 and 0×1 in field OC render bits 4 to 31 available to insert chip related information for control, configuration and/or recovery purposes. In case of this example, the remaining 28 bits are divided into field T (Type, bits 4-5), field S (Sequence, bits 6, 7) and field PL (PayLoad, bits 8-31). Fields T and S define a header and a sequence number, respectively, which enables partition of the SFCPs into several SFCPs and allows the receiving IOR, IOR′ to restore the full message.

Processing units IOR and IOR′ on each of chips 10 and 20 are used to encode the required control, configuration or recovery information into low-level communication packets which are defined by the used interface protocol SIP, such as manufacturer specific flow control packets in the InfiniBand® protocol. The packets are then inserted into the regular traffic flow on the sending chip, and filtered out of the incoming data stream on the receiving chip. The packets are decomposed and executed or directly transferred to the on-chip executing control logic C.

The present invention can be realized in hardware, software, or a combination of hardware and software. Any kind of computer system or other apparatus adapted for carrying out the methods described herein is suited. A typical combination of hardware and software could be a general purpose computer system with a computer program that, when being loaded and executed, controls the computer system such that it carries out the methods described herein.

The present invention can also be embedded in a computer program product, which comprises all the features enabling the implementation of the methods described herein, and which, when loaded in a computer system, is able to carry out these methods.

Computer program means or computer program in the present context mean any expression, in any language, code or notation, of a set of instructions intended to cause a system having an information processing capability to perform a particular function either directly or after either or both of the a conversion to another language, code or notation or reproduction in a different material form.

Furthermore, the method described herein may take the form of a computer program product accessible from a computer-usable or computer-readable medium providing program code for use by or in connection with a computer or any instruction execution system. For the purposes of this description, a computer-usable or computer readable medium may be any apparatus that can contain, store, communicate, propagate, or transport the program for use by or in connection with the instruction execution system, apparatus, or device. The medium may be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk, read only memory (CD-ROM), compact disk, read/write (CD-RW), and DVD.

While the invention has been described with reference to a preferred embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A method for inter-chip communication, wherein a communication protocol (CP) based on a standard interface protocol (SIP) is used, comprising:
determining chip related information, including data relevant for at least one of the following: control, configuration, recovery;
encoding said information within communication packets of a communication layer above the physical layer of the interface protocol;
inserting said communication packets into a regular traffic flow of a first transmitting chip;
extracting said information from an incoming data stream on a first receiving chip (20).

2. The method according to claim 1, wherein the communication packets are manufacturer specific flow control packets defined by OpCodes, which are not used by the standard interface protocol.

3. The method according to claims 2, wherein the standard interface protocol comprises an InfiniBand® protocol, preferably of Version 1.2, and wherein the communication layer for transferring the chip related information is the networking layer of the InfiniBand® protocol.

4. A computer program loadable into the internal memory of a digital computer system comprising software code portions for performing a method according to any of the claim 3 when said computer program is run on said computer system.

5. A computer program product comprising a computer usable medium embodying program instructions executable by a computer, said embodied program instructions comprising a computer program according to claim 4.

6. A processing unit for inter-chip communication comprising means to implement the method according to claim 3.

7. The processing unit of claim 6, said processing unit implemented on chip and connected to a link protocol engine of a main interface to a neighboring chip, and wherein said unit is connected to control and configuration mechanisms of said chip.

8. The processing unit according to claim 7, integrally formed with a control unit.

9. A computer system comprising a processing unit according to claim 7.
